(19) United States
(12) Patent Application Publication
(10) Pub. No.: US 2016/0360293 A1
(43) Pub. Date: Dec. 8, 2016

(54) METHOD AND APPARATUS FOR PLAYING 3D FILM SOURCES IN SMART TV

(71) Applicant: LE SHI ZHI XIN ELECTRONIC TECHNOLOGY (TIANJIN) LIMITED, Beijing (CN)

(72) Inventors: Bo HUANG, ChaoYang District, Beijing (CN); Han XIAO, ChaoYang District, Beijing (CN)

(21) Appl. No.: 15/100,496

(22) PCT Filed: Nov. 25, 2014
(86) PCT No.: PCT/CN2014/092190

§ 371 Date: May 31, 2016

(30) Foreign Application Priority Data
Dec. 13, 2013 (CN) 201310678085.4

(51) Int. Cl. H04N 21/81; H04N 21/472; H04N 21/462; H04N 21/44

(52) U.S. Cl. CPC H04N 21/816; H04N 21/44008; H04N 21/472; H04N 21/4621

(57) ABSTRACT

The present disclosure provides a method and device for playing a 3D source on a smart TV. Sources in smart TV system have flag bit information. The method includes: when receiving a request for playing a designated source, determining whether the designated source is a 3D source; if yes, determining a synthesis manner of the designated source, and modifying flag bit information of the designated source according to the synthesis manner; and when receiving a poll request sent from an underlying synthesis module, returning the modified flag bit information to the underlying synthesis module, so that when finding that the flag bit information is modified, the underlying synthesis module sends an instruction for playing the 3D source to a play module to notify the play module to synthesize the 3D source using a synthesis manner corresponding to the modified flag bit information and play the 3D source.

### CROSS-REFERENCE TO RELATED APPLICATIONS

This application is based upon and claims priority to Chinese Patent Application 201310678085.4, titled “Method and Device for Playing 3D Source on a Smart TV”, filed on Dec. 13, 2013, the entire contents of which are incorporated herein by reference.

### FIELD OF TECHNOLOGY

The present disclosure generally relates to the technical field of playing 3D sources on a smart television (TV), and more particularly to a method and a device for playing 3D source on a smart TV.

### BACKGROUND

Personal computers have become intelligent, and the intelligence degree of mobile phones and tablet computers is even higher. Accordingly, TVs are developed towards a trend of high definition, networking, and intelligence. Conforming to the trend, smart TVs increasingly enter our lives.

The so-called smart TV, likes a smart phone, typically has a full open platform, and an operating system running thereon which enables a user to install and uninstall programs such as various application software or games provided by TV manufactures or third-party service providers by himself or herself during enjoyment of TV contents. By such programs, functions of smart TVs can be continuously extended and updated. Further, smart TVs can be connected to networks, AV devices and PCs and the like, and can obtain program contents from various channels such as networks, AV devices, and PCs and the like. Also, by a simple and convenient integrated operation interface, smart TVs can clearly present the contents as desired by users on TV screens.

Like smart phones which enable to download various video websites in a form of application (APP) to make users click and play videos, the video websites can be customized on a desktop of a smart TV by pre-installation or downloading and installation, so that users can click and play videos. During the usage of the above application to play specific video programs, a need to play 3D sources may occur. A 3D source is usually obtained by synthesizing two video files which have perspective differences in shooting angles. Specific synthesis manners usually include a left-right synthesis manner and an up-bottom synthesis manner. In related technologies, when playing a 3D source in an application, it is needed to manually select a specific synthesis manner by users, and the procedure is relatively tedious. Also, for some users who lack of knowledge on 3D technologies, they may feel confused and thereby do not know how to select.

Thus, a technical problem which needs urgent solution from one or ordinary skill in this art is how to more automatically synthesize and play 3D sources and thereby to reduce user's operation costs.

### SUMMARY

One of the objectives of embodiments of the present disclosure is to provide a method and device for playing a 3D source on a smart TV so as to solve the above problem about how to more automatically synthesize and play 3D sources and thereby to reduce user's operation costs and improve efficiency.

According to an aspect of embodiments of the present disclosure, there is provided a method for playing a 3D source on a smart TV. Sources in a system of the smart TV have flag bit information. The method includes:

when receiving a request for playing a designated source, determining whether the designated source is a 3D source;

if the designated source is a 3D source, determining a synthesis manner of the designated source, and modifying flag bit information of the designated source according to the synthesis manner of the designated source, wherein the modified flag bit information is configured to indicate that the source is a 3D source and to indicate the synthesis manner of the 3D source; and

when receiving a poll request sent from an underlying synthesis module, returning the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

Optionally, the designated source is a source stored in a server of the smart TV, and 2D and 3D sources in the server are stored under different storage paths. When receiving a request for playing a designated source, the determining whether the designated source is a 3D source, includes:

when receiving the request for playing the designated source, extracting information regarding a storage path of the designated source from a play address of the designated source; and

if the extracted information regarding the storage path matches a pre-obtained storage path of a 3D source, determining that the designated source is a 3D source.

Optionally, 3D sources synthesized according to different synthesis manners are stored under different storage paths. The determining the synthesis manner of the designated source, includes:

extracting information regarding a storage path of the designated source from a play address of the designated source; and

performing matching between the extracted information regarding the storage path and pre-obtained storage paths for various synthesis manners, and if the extracted information matches a storage path for a synthesis manner, determining that the 3D source is synthesized according to the synthesis manner.

Optionally, the flag bit information is global flag bit information.

Optionally, the synthesis manner includes a left-right synthesis manner and an up-bottom synthesis manner, and different synthesis manners correspond to different flag bit information.

According to another aspect of embodiments of the present disclosure, there is provided a device for playing a 3D source on a smart TV. Sources in a system of the smart TV have flag bit information. The device includes:

one or more processors; and

a memory;

wherein one or more programs are stored in the memory, and when executed by the one or more processors, the one or more programs cause the one or more processors to:

when receive a request for playing a designated source, determine whether the designated source is a 3D source;

if the designated source is a 3D source, determine a synthesis manner of the designated source, and modify flag bit information of the designated source according to the synthesis manner of the designated source, wherein the modified flag bit information is configured to indicate that the source is a 3D source and to indicate the synthesis manner of the 3D source; and

when receive a poll request sent from an underlying synthesis module, return the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

Optionally, the designated source is a source stored in a server of the smart TV, and 2D and 3D sources in the server are stored under different storage paths;

the one or more processors are configured to:

when receive the request for playing the designated source, extract information regarding a storage path of the designated source from a play address of the designated source; and

if the extracted information regarding the storage path matches a pre-obtained storage path of a 3D source, determine that the designated source is a 3D source.

Optionally, 3D sources synthesized according to different synthesis manners are stored under different storage paths;

the one or more processors are configured to:

perform matching between the extracted information regarding the storage path and pre-obtained storage paths for various synthesis manners, and if the extracted information matches a storage path for a synthesis manner, determining that the 3D source is synthesized according to the synthesis manner.

Optionally, the flag bit information is global flag bit information.

Optionally, the synthesis manner includes a left-right synthesis manner and an up-bottom synthesis manner, and different synthesis manners correspond to different flag bit information.

Embodiments of the present disclosure further provide a computer readable recording medium, on which programs for performing any one of the above methods are recorded.

In embodiments of the present disclosure, during playing of 3D sources, users' operation costs can be reduced and thereby efficiency can be improved. Further, phenomena such as play errors due to users' inadvertent operations can be avoided.

### BRIEF DESCRIPTION OF THE DRAWINGS

One of ordinary skill in this art will appreciate other advantages from the following detailed description of exemplary embodiments herein. Drawings are only for showing exemplary embodiments but not for limiting the scope of the present disclosure. Through the drawings, similar reference numbers represent similar elements.

FIG. 1 is a flowchart showing a method for playing a 3D source on a smart TV according to an embodiment of the present disclosure; and

FIG. 2 is a block diagram showing a device for playing a 3D source on a smart TV according to an embodiment of the present disclosure.

### DESCRIPTION OF THE EMBODIMENTS

In order to make the above objectives, features and advantages of embodiments of the present disclosure more clear, the present disclosure will be described below in detail with reference to drawings and specific implementations.

Firstly, it shall be noted that in order to more automatically synthesize and play 3D sources and thereby reduce users' operation costs, embodiments of the present disclosure may perform improvements based on the application for cycle play of channel programs in a smart TV as mentioned in the above BACKGROUND section. That is to say, in the technical solutions provided by embodiments of the present disclosure, respective steps are performed by the application. For the convenience in description, the application is referred to as a cycle play application. Specific implementations of embodiments of the present disclosure will be described in detail below.

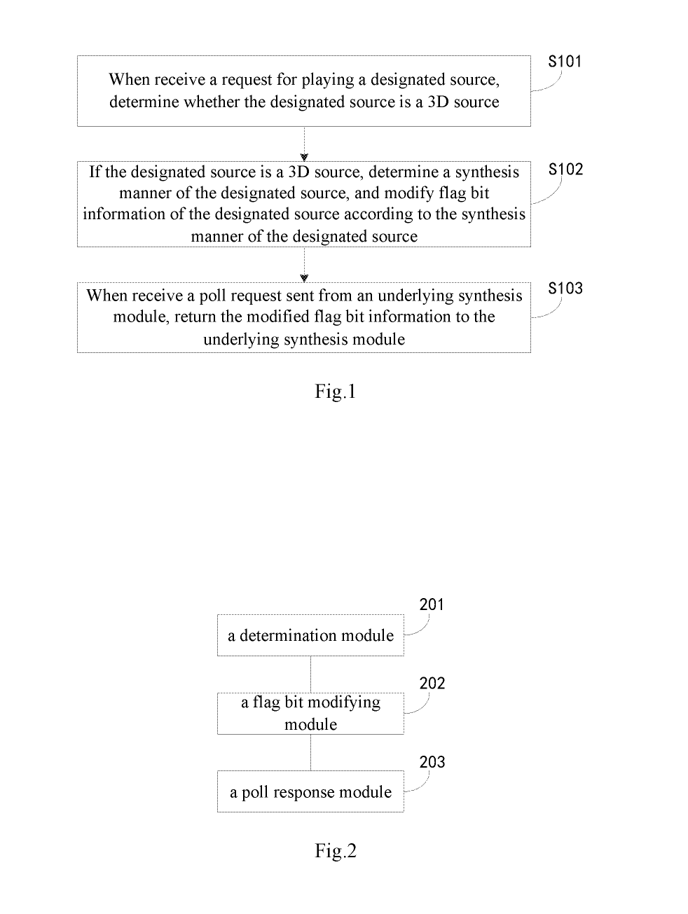

Referring to FIG. 1, embodiments of the present disclosure firstly provide a method for playing a 3D source on a smart TV, which includes the following methods.

In step S101, when a request for playing a designated source is received, whether the designated source is a 3D source is determined.

In embodiments of the present disclosure, a 3D command sending module may be included in the cycle play application. When a user wants to watch a certain 3D source, an instruction for playing the 3D source may be sent to the cycle play application. After receiving the instruction for playing the source, the cycle play application may firstly determine whether the source is a 3D source. If the source is not a 3D source, the cycle play application sends a command to an underlying play module to instruct the play module to perform playing according to usual 2D source playing procedures. However, if the source is a 3D source, step S102 is performed to proceed with subsequent processes. Whether a source is a 3D source may be determined using many approaches. For example, in an implementation, various sources are collected and provided by a server of the smart TV in advance, and the server usually stores 2D and 3D sources under different storage paths, and thus after receiving a request for playing a current designated source, the cycle play application may directly determine whether the designated source is a 3D source according to the storage path of the designated source. Specifically, the server usually provides a play address to each of the sources, and the play address usually includes information regarding a storage path of the source in the server. Thus, the storage path of the source may be extracted according to the play address of the current designated source, and then whether the current source to be played is a 3D source may be determined according to the path. For example, if the extracted information regarding the storage path matches a pre-stored storage path of a 3D source, it is determined that the designated source is a 3D source.

In step S102, if the designated source is a 3D source, a synthesis manner of the designated source is determined, and flag bit information of the designated source is modified according to the synthesis manner of the designated source. The modified flag bit information is configured to indicate that the source is a 3D source and to indicate the synthesis manner of the 3D source.

If it is determined that the current source to be played is a 3D source, a synthesis manner corresponding to the 3D source may be determined automatically. The synthesis manner employed by a 3D source is related to a shooting manner of the 3D source. For example, if shooting is performed using two cameras having certain perspective differences at the left and right directions, a left-right synthesis needs to be performed on the images captured by the two cameras. Alternatively, if shooting is performed using two cameras having certain perspective differences at the up and bottom directions, an up-bottom synthesis needs to be performed on the images captured by the two cameras. In embodiments of the present disclosure, during collection of 3D sources, the server may obtain the information regarding the synthesis manners of the 3D sources. For example, if a 3D source is uploaded onto the server by a writer, the uploader may be requested to provide information regarding the synthesis manner when uploading the 3D source, so that the server may mark the source. Alternatively, the server may create different folders for different synthesis manners, and request uploaders to upload 3D sources onto corresponding folders according to the synthesis manners of the sources. Thus, whether a 3D source is synthesized using a left-right synthesis manner or an up-bottom synthesis manner may be determined according to specific storage path of the source. Thus, information regarding the storage path of the designated source may be extracted from the play address of the designated source, and matching between the extracted information regarding the storage path and pre-obtained storage paths for various synthesis manners is performed. If the extracted information regarding the storage path matches a certain storage path of a 3D source, it is determined that the 3D sourced is synthesized using the synthesis manner. In other words, after the user sends the request for playing a certain source, not only that the source is a 3D source may be known from the play address of the source, but also the synthesis manner of the 3D source may be further obtained.

After obtaining the synthesis manner of the 3D source, a flag bit of the source may be modified. This is one of the key steps in embodiments of the present disclosure. That is to say, a flag bit (which may be a global flag) may be set for each of the sources, and the flag bit may be set as a default value such as “0” by default. When the user designates a certain source for play, and the cycle play application determines that the source is 3D source and also determines the synthesis manner of the 3D source, the flag bit may be modified. For example, it may be defined in advance that the value corresponding to the left-right synthesis manner is “2”, and the value corresponding to the up-bottom synthesis manner is “3”. After determining that one source corresponds to the left-right synthesis manner, the flag bit may be modified from “0” to “2”. After determining that source corresponds to the up-bottom synthesis manner, the flag bit may be modified from “0” to “3”. Rather, the specific numbers in the above descriptions are only for illustrative purposes but shall not be deemed as limitation to the protection scope of the present disclosure.

In step S103, when a poll request sent from an underlying synthesis module is received, the modified flag bit information is returned to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

At the same time when the cycle play application performs operations such as the determinations and flag modification in steps S101 and S102, the underlying synthesis module continuously sends a poll request to an upper application, and after the upper application modifies the flag bit, the upper application returns the modification event and the modified value to the underlying synthesis module. In this way, the underlying synthesis module may know whether the source is a 3D source. If the source is a 3D source, the needed synthesis manner may be determined directly according to the modified value. After determining the needed synthesis manner, an instruction for playing the 3D source may be sent to the underlying play module, for example, a Frame Rate Conversion (FRC) module to notify the play module to synthesize the 3D source using the synthesis manner corresponding to the modified flag bit information and play the 3D source.

In conclusion, in embodiments of the present disclosure, when a user needs to play a 3D source, he/she only needs to select the source to be played, and no manual selection of a synthesis manner of the source is needed. A cycle play application can determine and modify a flag bit by itself, and accordingly, an underlying synthesis module and a play module can synthesize the 3D source according to the flag bit modification event and the modified flag bit and play the 3D source, and the like. Thus, during playing of 3D sources, users' operation costs can be reduced and thereby efficiency can be improved. Further, phenomena such as play errors due to users' inadvertent operations can be avoided.

Corresponding to the methods for playing a 3D source on a smart TV provided by embodiments of the present disclosure, embodiments of the present disclosure further provides a device for playing a 3D source on a smart TV. Sources in a system of the smart TV have flag bit information. Referring to FIG. 2, the device includes a determination module 201, a flag bit modifying module 202 and a poll response module 203.

The determination module 201 is configured to, when a request for playing a designated source is received, determine whether the designated source is a 3D source.

The flag bit modifying module 202 is configured to, if the determination module 201 determines that the designated source is a 3D source, determine a synthesis manner of the designated source, and modify flag bit information of the designated source according to the synthesis manner of the designated source. The modified flag bit information is configured to indicate that the source is a 3D source and to indicate the synthesis manner of the 3D source.

The poll response module 203 is configured to, when a poll request sent from an underlying synthesis module is received, return the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

The designated source is a source stored in a server of the smart TV, and 2D and 3D sources in the server are stored under different storage paths. The determination module 201 may include a path information extracting module and a determination sub-module.

The path information extracting module is configured to, when the request for playing the designated source is received, extract information regarding a storage path of the designated source from a play address of the designated source.

The determination sub-module is configured to, if the extracted information regarding the storage path matches a pre-obtained storage path of a 3D source, determine that the designated source is a 3D source.

The 3D sources synthesized according to different synthesis manners are stored under different storage paths. The flag bit modifying module includes a path information extracting module and a matching module.

The path information extracting module is configured to extract information regarding a storage path of the designated source from a play address of the designated source.

The matching module is configured to perform matching between the extracted information regarding the storage path and pre-obtained storage paths for various synthesis manners, and if the extracted information matches a storage path for a synthesis manner, determine that the 3D source is synthesized according to the synthesis manner.

The flag bit information is global flag bit information.

The synthesis manner includes a left-right synthesis manner and an up-bottom synthesis manner, and different synthesis manners correspond to different flag bit information.

In the device for playing a 3D source on a smart TV provided by the above embodiments of the present disclosure, when a user needs to play a 3D source, he/she only needs to select the source to be played, and no manual selection of a synthesis manner of the source is needed. A cycle play application can determine and modify a flag bit by itself, and accordingly, an underlying synthesis module and a play module can synthesize the 3D source according to the flag bit modification event and the modified flag bit and play the 3D source, and the like. Thus, during playing of 3D sources, users' operation costs can be reduced and thereby efficiency can be improved. Further, phenomena such as play errors due to users' inadvertent operations can be avoided.

Embodiments of the present disclosure further provide a computer readable recording medium, on which programs for performing any one of the methods according to the embodiments of the present disclosure are recorded.

The computer readable recording medium includes any mechanism for storing or transmitting information in a computer readable form, for example, a computer. For example, a machine readable medium includes a Read Only Memory (ROM), a Random Access Memory (RAM), a magnetic storage medium, an optical storage medium, a flash storage medium, transmission signals in a form of electricity, light, or sound or other forms of signals (for example, a carrier wave, an infrared signal, or a digital signal, and the like).

For convenience in description, the above embodiments of the methods are described as combinations of a series of actions, and however, one of ordinary skill in this art shall appreciate that the present disclosure is not limited to the sequence between actions as disclosed herein. Actually, according to the present disclosure, some steps may be performed in other sequences or simultaneously. In addition, one of ordinary skill in this art shall understand that the above embodiments of the methods are exemplary embodiments, and not all the involved actions and modules are essential to the present disclosure.

For convenience in description, the above embodiments of the devices are described as combinations of a series of modules, and however, one of ordinary skill in this art shall appreciate that the present disclosure is not limited to the combination manners of modules as disclosed herein. Actually, according to the present disclosure, the actions performed by some modules may be performed by other modules. In addition, one of ordinary skill in this art shall understand that the above embodiments of the devices are exemplary embodiments, and not all the involved modules are essential to the present disclosure.

Respective embodiments of the present disclosure are described in a progressive way, and the emphasis of descriptions regarding each embodiment reside in the differences of the embodiment from other embodiments, and for parts in one embodiment which are similar to other embodiments, the descriptions regarding the other embodiments may be referred to. The embodiments of the systems/devices are similar to the embodiments of the methods, and thus the descriptions regarding the systems/devices are relatively simple, and the descriptions regarding the embodiments of the method may be referred to.

The methods and devices for playing a 3D source on a smart TV provided by the present disclosure are illustrated above in detail. Specific examples are provided in the present disclosure to explain the principles and implementations of the present disclosure, and the explanations of the above embodiments are only for facilitating understanding of the core of the methods in the present disclosure. Meanwhile, based on the spirit of the present disclosure, one of ordinary skill in this art may modify the specific implementations and application ranges. In a word, the contents in the descriptions shall not be deemed as limitations to the present disclosure.

1-11. (canceled)

12. A method for playing a 3D source on a smart TV, wherein sources in a system of the smart TV have flag bit information, and the method comprises:
when receiving a request for playing a designated source, determining whether the designated source is a 3D source;
if the designated source is a 3D source, determining a synthesis manner of the designated source, and modifying flag bit information of the designated source according to the synthesis manner of the designated source, wherein the modified flag bit information is configured to indicate that the source is a 3D source and to indicate the synthesis manner of the 3D source; and
when receiving a poll request sent from an underlying synthesis module, returning the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

13. The method for playing a 3D source on a smart TV according to claim 12, wherein the designated source is a source stored in a server of the smart TV, and 2D and 3D sources in the server are stored under different storage paths;
wherein when receiving a request for playing a designated source, the determining whether the designated source is a 3D source, comprises:
when receiving the request for playing the designated source, extracting information regarding a storage path of the designated source from a play address of the designated source; and
if the extracted information regarding the storage path matches a pre-obtained storage path of a 3D source, determining that the designated source is a 3D source.

14. The method for playing a 3D source on a smart TV according to claim 13, wherein 3D sources synthesized according to different synthesis manners are stored under different storage paths, and
wherein the determining the synthesis manner of the designated source, comprises:
performing matching between the extracted information regarding the storage path and pre-obtained storage paths for various synthesis manners, and if the extracted information matches a storage path for a synthesis manner, determining that the 3D source is synthesized according to the synthesis manner.

15. The method for playing a 3D source on a smart TV according to 12, wherein the flag bit information is global flag bit information.

16. The method for playing a 3D source on a smart TV according to claim 13, wherein the flag bit information is global flag bit information.

17. The method for playing a 3D source on a smart TV according to claim 13, wherein the flag bit information is global flag bit information.

18. The method for playing a 3D source on a smart TV according to claim 12, wherein the synthesis manner comprises a left-right synthesis manner and an up-bottom synthesis manner, and different synthesis manners correspond to different flag bit information.

19. The method for playing a 3D source on a smart TV according to claim 13, wherein the synthesis manner comprises a left-right synthesis manner and an up-bottom synthesis manner, and different synthesis manners correspond to different flag bit information.

20. The method for playing a 3D source on a smart TV according to claim 14, wherein the synthesis manner comprises a left-right synthesis manner and an up-bottom synthesis manner, and different synthesis manners correspond to different flag bit information.

21. A device for playing a 3D source on a smart TV, wherein sources in a system of the smart TV have flag bit information, and the device comprises:
one or more processors; and
a memory;
wherein one or more programs are stored in the memory, and when executed by the one or more processors, the one or more programs cause the one or more processors to:
when receive a request for playing a designated source, determine whether the designated source is a 3D source;
if the designated source is a 3D source, determine a synthesis manner of the designated source, and modify flag bit information of the designated source according to the synthesis manner of the designated source, wherein the modified flag bit information is configured to indicate that the source is a 3D source and to indicate the synthesis manner of the 3D source; and
when receive a poll request sent from an underlying synthesis module, return the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.

22. The device for playing a 3D source on a smart TV according to claim 21, wherein the designated source is a source stored in a server of the smart TV, and 2D and 3D sources in the server are stored under different storage paths;
the one or more processors are configured to:
when receive the request for playing the designated source, extract information regarding a storage path of the designated source from a play address of the designated source; and
if the extracted information regarding the storage path matches a pre-obtained storage path of a 3D source, determine that the designated source is a 3D source.

23. The device for playing a 3D source on a smart TV according to claim 22, wherein 3D sources synthesized according to different synthesis manners are stored under different storage paths;
the one or more processors are configured to:
perform matching between the extracted information regarding the storage path and pre-obtained storage paths for various synthesis manners, and if the extracted information matches a storage path for a synthesis manner, determining that the 3D source is synthesized according to the synthesis manner.

24. The device for playing a 3D source on a smart TV according to claim 21, wherein the flag bit information is global flag bit information.

25. The device for playing a 3D source on a smart TV according to claim 22, wherein the flag bit information is global flag bit information.

26. The device for playing a 3D source on a smart TV according to claim 23, wherein the flag bit information is global flag bit information.

27. The device for playing a 3D source on a smart TV according to claim 21, wherein the synthesis manner comprises a left-right synthesis manner and an up-bottom synthesis manner, and different synthesis manners correspond to different flag bit information.

28. The device for playing a 3D source on a smart TV according to claim 22, wherein the synthesis manner comprises a left-right synthesis manner and an up-bottom synthesis manner, and different synthesis manners correspond to different flag bit information.

29. The device for playing a 3D source on a smart TV according to claim 23, wherein the synthesis manner comprises a left-right synthesis manner and an up-bottom synthesis manner, and different synthesis manners correspond to different flag bit information.

30. A computer readable recording medium, on which programs for performing a method for playing a 3D source in a smart TV are recorded, wherein sources in a system of the smart TV have flag bit information, and the method comprises:
when receiving a request for playing a designated source, determining whether the designated source is a 3D source;
if the designated source is a 3D source, determining a synthesis manner of the designated source, and modifying flag bit information of the designated source according to the synthesis manner of the designated source, wherein the modified flag bit information is configured to indicate that the source is a 3D source and to indicate the synthesis manner of the 3D source; and
when receiving a poll request sent from an underlying synthesis module, returning the modified flag bit information to the underlying synthesis module, so that when the underlying synthesis module finds that the flag bit information is modified, the underlying synthesis module sends an instruction for playing the 3D source to a play module to notify the play module to synthesize the 3D source using a synthesis manner corresponding to the modified flag bit information and play the 3D source.
